(19) United States
(12) Patent Application Publication
(10) Pub. No.: US 2009/0020971 A1
(43) Pub. Date: Jan. 22, 2009

(54) Shopping Cart

(76) Inventor: Edgard Makdisse, Perdizes-Sao Paulo Cep (BR)

Correspondence Address: WILSON DANIEL SWAYZE, JR., 3804 CLEARWATER CT., PLANO, TX, 75025, US

(21) Appl. No.: 11/779,382

(22) Filed: Jul. 18, 2007

(51) Int. Cl. B62B 1/00

(52) U.S. Cl. 280/64

(57) ABSTRACT

A shopping cart includes a basket including structural rods and opposing rods, a substantially flat front member, a substantially flat back member, a first rotatable side member to connect to the substantially flat front member, and a second rotatable side member to connect to the substantially flat back member. The first rotatable side member and the second rotatable side member rotate to expand and reduce the depth of the shopping cart. The substantially flat front member is U-shaped, and the substantially flat back member is U-shaped. The shopping cart includes a bottom frame member to rotate adjacent to the back frame member, and the shopping cart includes a shelf frame member to rotate adjacent to the back frame member. The shopping cart includes a bag holder member, and the bag holder member is slidable.

### FIELD OF THE INVENTION

This invention relates to a wheeled shopping cart and, more specifically, to improvements associated with a basket as provided on the cart.

### BACKGROUND OF THE INVENTION

Wheeled shopping carts as conventionally utilized in department stores, supermarkets and related environments typically employ a large upwardly-opening basket for accommodating merchandise therein.

Most shopping carts known which comprise a shopping basket supported above ground by a frame displaceable on castors have a basket constructed of wire meshing. These carts are utilized in convenience stores whereby to transport the goods purchased by a person walking through the convenience store pushing the cart.

### SUMMARY

A shopping cart includes a basket including structural rods and opposing rods, a substantially flat front member, a substantially flat back member, a first rotatable side member to connect to the substantially flat front member, and a second rotatable side member to connect to the substantially flat back member. The first rotatable side member and the second rotatable side member rotate to expand and reduce the depth of the shopping cart.

The substantially flat front member is U-shaped, and the substantially flat back member is U-shaped.

The shopping cart includes a bottom frame member to rotate adjacent to the back frame member, and the shopping cart includes a shelf frame member to rotate adjacent to the back frame member.

The shopping cart includes a bag holder member, and the bag holder member is slidable.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the shopping cart in accordance with the teachings of the present invention;

FIG. 2 illustrates a cross-sectional view of the side of the shopping cart in accordance with the teachings of the present invention;

FIG. 3 illustrates a perspective view of the basket of the shopping cart of the present invention;

FIG. 4a illustrates a perspective view of the hinge of the shopping cart of the present invention;

FIG. 4b illustrates a perspective view of the locking apparatus;

FIG. 4c illustrates a perspective view of these sliding bag holder member;

FIG. 4d illustrates a perspective view of the foot member; and

FIG. 5 illustrates a folded shopping cart of the present invention;

FIG. 6a illustrates a cross-section view (B:B) of the shopping cart;

FIG. 6b illustrates a top view of the shopping cart;

FIG. 7a illustrates a perspective view of the U-shaped front frame member and foot member;

FIG. 7b illustrates a side view of the U-shaped front frame member and foot member;

FIG. 7c illustrates a detail view of the 7b view front frame member.

### DETAILED DESCRIPTION

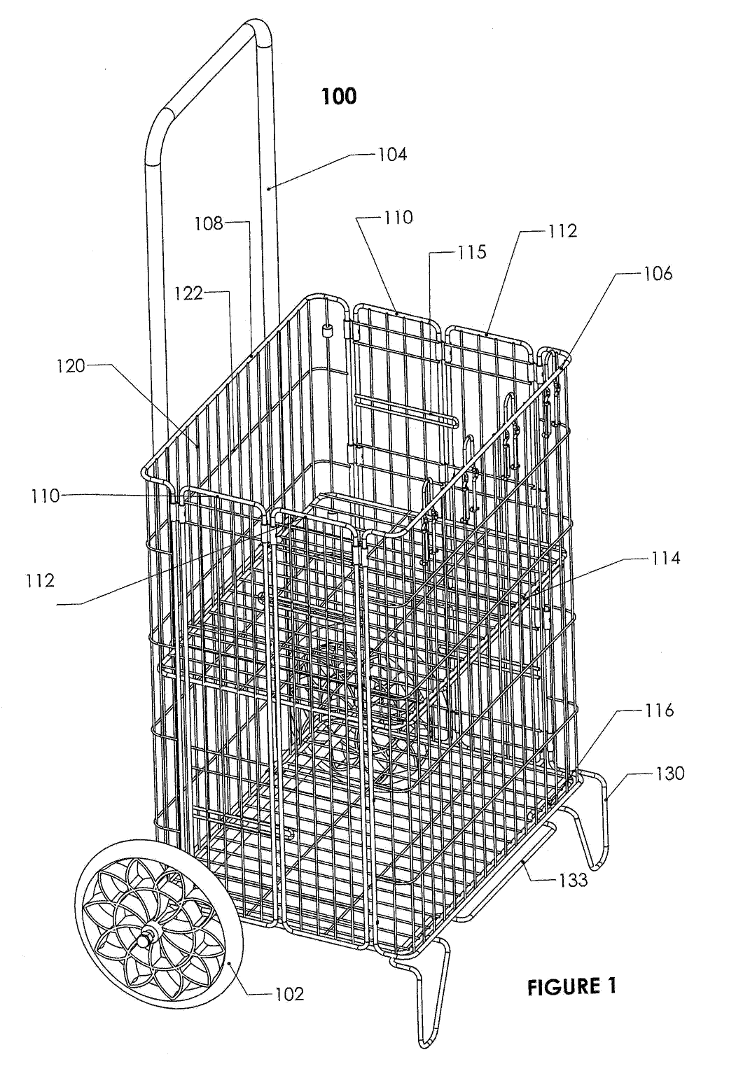

FIG. 1 illustrates a shopping cart 100 which includes structural support frame which includes spaced apart structural rods 120 which are shown in the vertical direction and these spaced apart structural rods 120 are welded or attached to opposing rods 122 which are shown in the horizontal direction. The direction of the spaced apart structural rods 120 and the oppose rods 122 could be reversed. The structural support frame to form the basket for goods includes a U-shaped front frame member 106 including arms which extend towards the back of the shopping cart 100 and provides a substantially flat vertical front. The structural support frame includes a U-shaped back frame member 108 which includes arms which extend towards the front of the shopping cart 100 and provides a substantially flat vertical back.

FIG. 1 additionally illustrates a bottom frame member 116 which provides a substantially flat bottom and which rotates from a position which is substantially perpendicular to the U-shaped front frame member 106 and the U-shaped back frame member 108 to a position which is substantially perpendicular and adjacent to the U-shaped back frame member 108.

FIG. 1 additionally illustrates a shelf frame member 114 which provides a substantially flat shelf positioned approximately in the middle of the shopping cart 100 and which rotates from a position which is substantially perpendicular to the U-shaped front frame member 106 and which is substantially perpendicular to the U-shaped back frame member 108 to a position which is substantially perpendicular and adjacent to the U-shaped back frame member of 108.

FIG. 1 additionally illustrates that the structural support frame includes a first rectangular side frame member 110 and a second rectangular side frame member 112 which are substantially rectangular and substantially flat, and both the first rectangular side frame member 110 and the second rectangular side frame member 112 rotate inwards and allows the shopping cart 100 to be reduced in depth. Both sides of the shopping cart 100 includes the first rectangular side frame member 110 and the second rectangular side frame member 112, and both sides of the shopping cart 100 operate in substantially the same manner.

FIG. 1 additionally illustrates that the shopping cart 100 includes a pair of wheels 102 on opposed sides of the shopping cart 100 to allow the shopping cart 100 to be easily transported, a pair of feet members 130 to support the shopping cart 100 of the present invention, and a handle 104 to allow the user to move the shopping cart 100. One foot member 130 is connected to another front member in 130 by a support segment 133 which extends beyond the U-shaped front frame member of 106 to support the shopping cart 100.

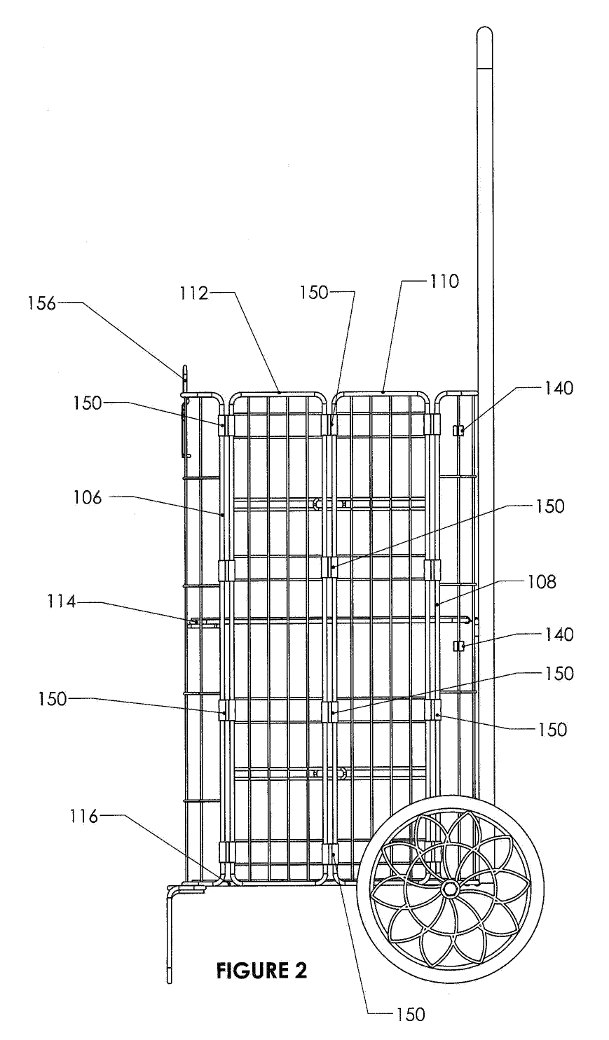

FIG. 2 illustrates a side view of the shopping cart 100 and illustrates the first rectangular side frame member 110 and the opposing second rectangular side frame member 112 which rotate inwardly. FIG. 2 illustrates that the first rectangular side frame member 110 and the second rectangular side frame member 112 are rotatively connected to the U-shaped front frame member 106 and the U-shaped back frame member 108 respectively by a hinge 150 so that the first rectangular side frame member 110 and the second rectangular side frame member 112 can rotate inwards to reduce the depth of the shopping cart 100 and rotate outwards to increase the depth of the shopping cart 100. FIG. 2 additionally illustrates that the first rectangular side frame member 110 is rotatably connected to the second rectangular side frame member 112. FIG. 2 illustrates that the bottom frame member 116 and the shelf frame member 114 rotates from a perpendicular position with respect to the front back and side members 106, 108, 110 and 112 to a vertical position adjacent to the back frame member 108 to allow the depth of the shopping cart 100 to be reduced to provide a compact shopping cart 100. FIG. 2 illustrates a locking apparatus 140 on the back frame member 108 to lock the bottom frame member 116 and the shelf frame member 114 in position against the U. shaped back frame member 108.

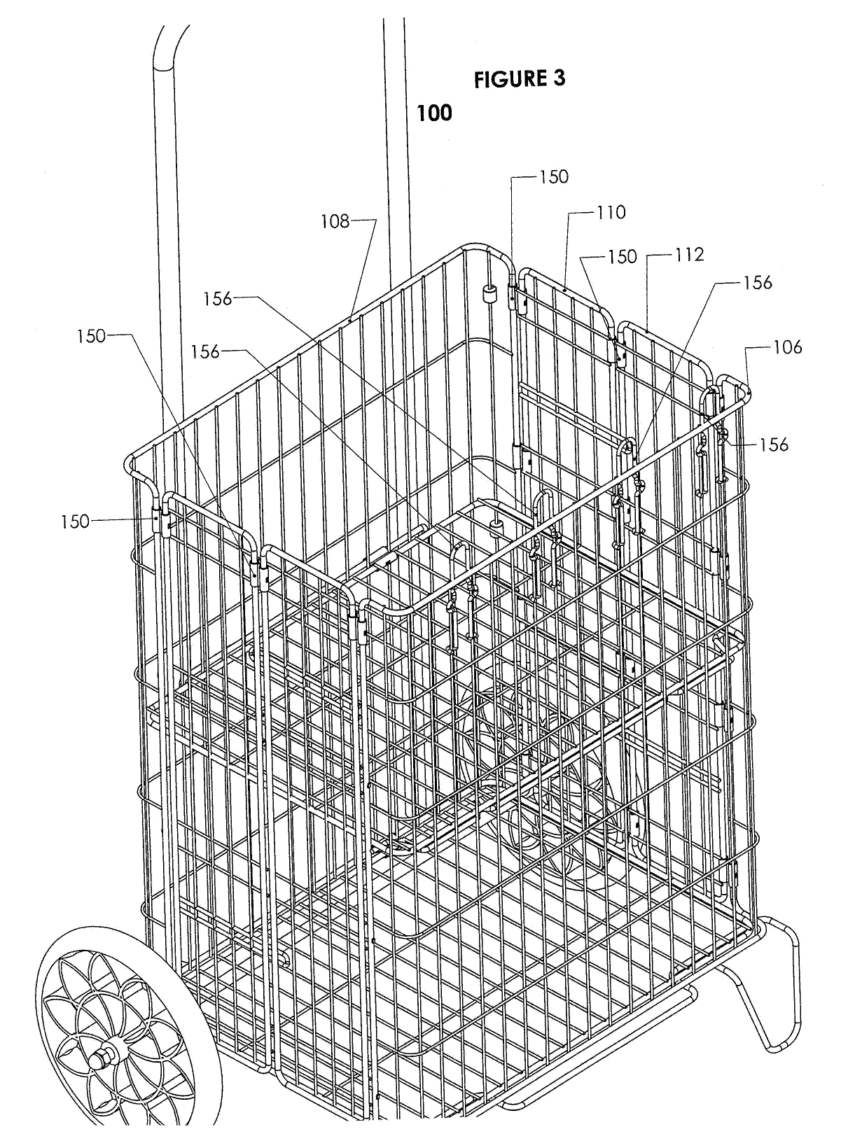

FIG. 3 illustrates a partial view of the shopping cart 100 of the present invention. FIG. 3 illustrates the U-shaped front frame member 106, the U-shaped back frame member 108, the first rectangular side frame member 110 and the second rectangular side frame member 112.

FIG. 3 illustrates a U-shaped sliding bag member 156 which moves up and down along a pair of spaced structural rods 120 between an extended and a retracted position to be able to hold shopping bags, handbags in order to aid the user.

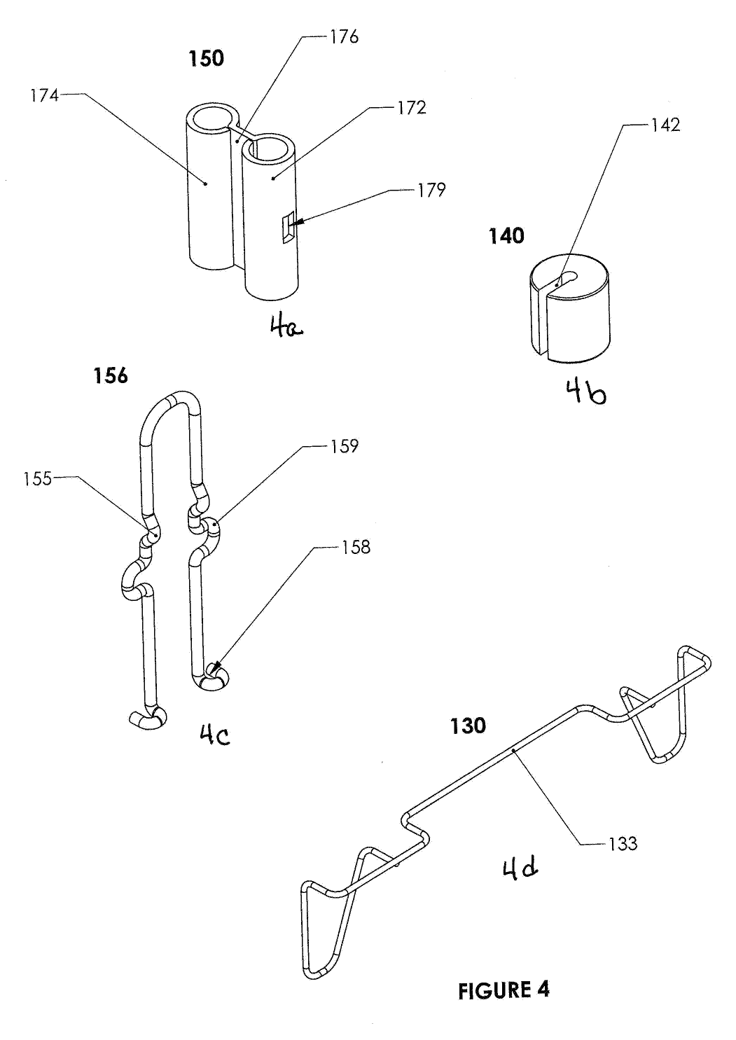

FIG. 4a illustrates the hinge member 150 which includes a first cylinder member 172 and a second cylinder member 174 to cooperate with the structural rods 120 so that the first rectangular side frame member 110 and the second rectangular side frame member 112 may rotate inwards and outwards by rotating over the rods 120. The first cylinder member 172 includes an aperture 179 to cooperate with a outwardly extending radial projection 180 to prevent the first cylinder member 172 from rotating on the supporting rod 120. The second cylinder member 174 does rotate with respect to another supporting rod 120. The first cylinder member 172 and the second cylinder member 174 are connected by a connecting plate member 176 to connect the first cylinder member 172 and the second cylinder member 174 in a spaced relationship.

FIG. 4b illustrates a perspective view of the locking apparatus 140 which may include a central aperture for positioning on the supporting rod 120. The central aperture may include a radial slot 142 to cooperate with a supporting rod 120 of the bottom frame member 116 or the shelf frame member 114. The radial slot 142 is dimensioned to provide a friction fit with the supporting rod 120 of the bottom frame member 116 or the supporting rod 120 of the shelf frame member 114.

FIG. 4c illustrates the sliding bag holder member 156 including a traverse U-shaped segment 158 and a longitudinal U-shaped segment 159 to cooperate with a supporting rod 120 of the U-shaped front frame member 106 or any other frame member 118, 110 114, 116 to move along the supporting rod 120. The sliding bag holder member 156 includes an outward U-shaped segment 155 to limit the movement of the sliding bag holder member 156 by abutting the opposing rods 122.

FIG. 4d illustrates the foot member 130 which includes the support segment 133.

The supporting rods 120, the opposing rods, the U-shaped front frame member 106, the U-shaped back frame member of 108, the first rectangular side frame member 110, the second rectangular side frame member 112 and the hinge member 150 are formed from rigid materials such as steel or iron or other suitable material that is used for a shopping cart. It is within the scope of the present invention to use rigid plastic material.

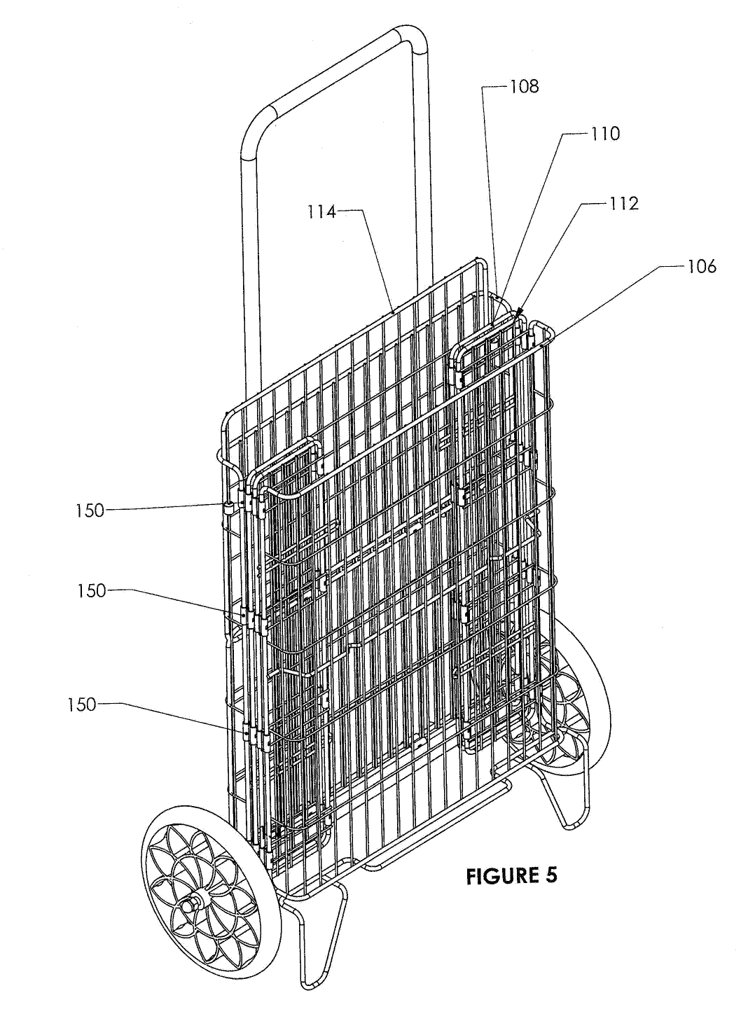

FIG. 5 illustrates a folded shopping cart 100 in accordance with the teachings of the present invention. FIG. 5 illustrates that the first rectangular side frame member 110 and the second rectangular side frame member 112 have been folded together between the U-shaped front frame member 106 and the U-shaped back frame member 108 so the first rectangular side frame member 110 is adjacent to the second rectangular side frame member 112 to reduce the depth of the shopping cart 100.

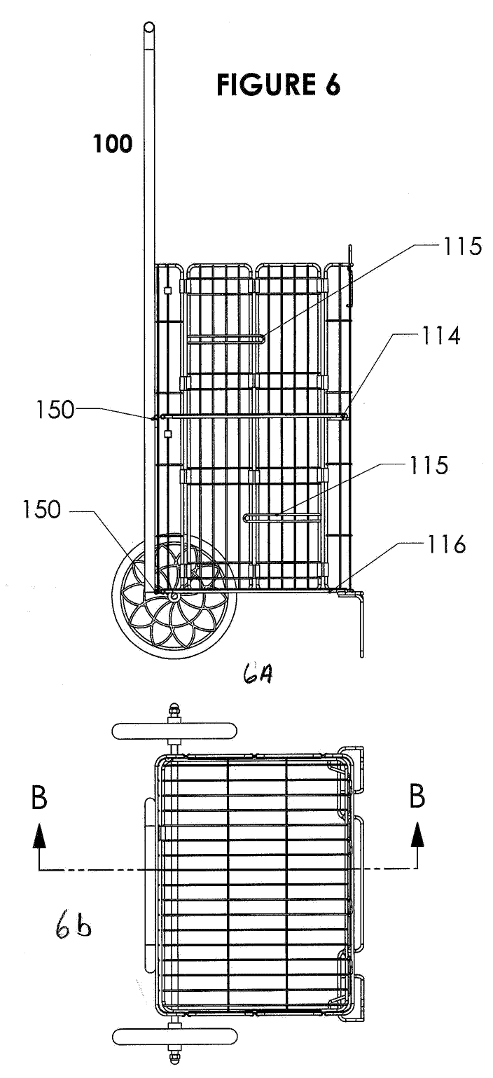

FIG. 6a illustrates a sectional view along line B-B as shown in FIG. 6b of the shopping cart 100 and illustrates the hinges 150 for the shelf frame member 114 and the bottom frame member 116. FIG. 6a additionally illustrates traverse support member 115 which is positioned on the first and second rectangular side frame member 110, 112 and extends beyond the side of the first and second rectangular side frame member 110, 112 to stop either the first or second rectangular side frame member 110, 112 from bowing outwards.

FIG. 6b illustrates the top of the shopping cart 100 and the sectional line B-B for FIG. 6a.

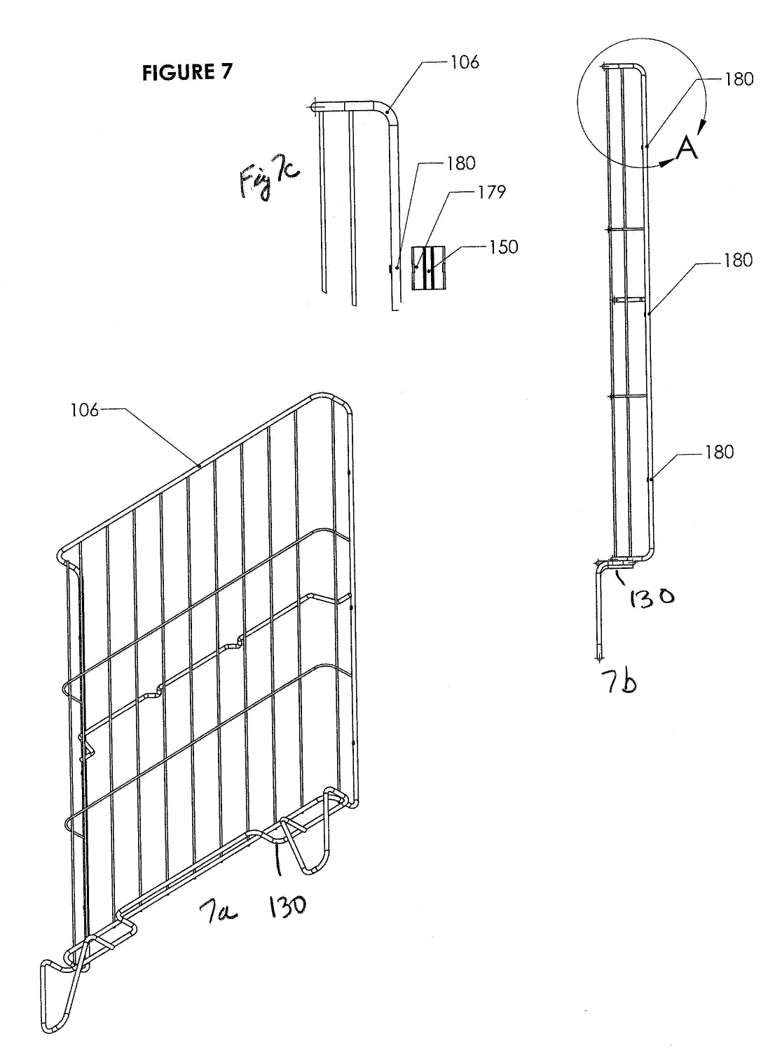

FIG. 7a illustrates a perspective view of the U-shaped front frame member 106 and the foot member 130.

FIG. 7b illustrates a side view of the U-shaped front frame member 106 and the foot member 130. FIG. 7b additionally illustrates the outwardly extending radial projection 180 for cooperating with the hinge 150. FIG. 7b additionally illustrates a section A shown in FIG. 7c. FIG. 7c illustrates the outward extending radial projection 180 which can be used in conjunction with the U-shaped front frame member 106 or the U-shaped back frame member 108 to cooperate with the aperture 179 of the hinge 150.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A shopping cart, comprising:
a basket including structural rods and opposing rods, a substantially flat front member;
a substantially flat back member;
a first rotatable side member to connect to the substantially flat front member;
a second rotatable side member to connect to the substantially flat back member;
wherein the first rotatable side member and the second rotatable side member rotate to expand and reduce the depth of the shopping cart.

2) A shopping cart as in claim 1, wherein the substantially flat front member is U-shaped.

3) A shopping cart as in claim 1, wherein the substantially flat back member is U-shaped.

4) A shopping cart as in claim 1, wherein the shopping cart includes a bottom frame member to rotate adjacent to the back frame member.

5) A shopping cart as in claim 1, wherein the shopping cart includes a shelf frame member to rotate adjacent to the back frame member.

6) A shopping cart as in claim 1, wherein the shopping cart includes a bag holder member.

7) A shopping cart as in claim 6, wherein the bag holder member is slidable.
